(19) United States
(12) Patent Application Publication
(10) Pub. No.: US 2015/0135135 A1
(43) Pub. Date: May 14, 2015

(54) Method for Image Controlling and Portable Electronic Apparatus Using the Same

(71) Applicant: Acer Inc., New Taipei City (TW)

(72) Inventor: Jhao-Dong Chiu, New Taipei City (TW)

(73) Assignee: Acer Inc., New Taipei City (TW)

(21) Appl. No.: 14/162,815

(22) Filed: Jan. 24, 2014

(30) Foreign Application Priority Data
Nov. 13, 2013 (TW) 102141361

(51) Int. Cl. G06F 3/0484; G06F 3/0488

(52) U.S. Cl. CPC G06F 3/04845; G06F 3/04847; G06F 3/0488
USPC 715/799

(57) ABSTRACT

A method for image controlling is disclosed. The method is applied in a portable electronic device, wherein the portable electronic device comprises a touch display module. The method comprises: defining a signal input area on the touch display module; detecting input signal on the signal input area; and displaying a first control interface on the touch display module, wherein the displayed ratio of the first control interface varies according to changes in a sliding distance of a track formed by the input signal.

### BACKGROUND OF THE INVENTION

1. Field of the Invention

The present invention relates to a method for image controlling and a portable electronic device using the same, and in particular relates to a method for image controlling which rapidly unlocks a locked screen mode and a portable electronic device using the same.

2. Description of the Related Art

As technologies develop and consumer demands increase, new portable electronic devices, such as the tablet computer, smart phone, personal digital assistant (PDA), and notebook computer, have become common in everyday life. The smart phone, for example, provides not only all functions of a traditional communication device but also a built-in Windows operating system so that users can process a document, send and receive email, browse the Internet, or use instant communication applications. Such devices have become indispensable tools to modern people demanding higher efficiency.

However, as the capabilities of portable electronic devices increase, the amount of power required for operating also increases. In order to boost the efficiency of a portable electronic device, power management is a critical function. Typically, when a portable electronic device is not in use, it is defaulted to enter into a hibernation mode or a locked mode, which reduces power consumption. In order to return to the normal operation mode from the hibernation mode or the locked mode, complicated operating steps are required (for example, pressing a power button and then drawing an unlock symbol), which is not convenient to users.

On the other hand, when a portable electronic device is in a hibernation mode or a locked mode, and at the same time has an unanswered call, text message, or a scheduled reminder, a user has to manually switch the portable electronic device to the normal operation mode in order to browse any such messages. In other words, the user must execute a series of button pressing operations in order to browse the messages. It is inconvenient to the user and increases the risk that the user will miss important messages or scheduled reminders.

Accordingly, it is desirable to provide a method for image controlling and a portable electronic device for using the method in order to resolve the drawbacks of the prior art.

### SUMMARY OF THE INVENTION

One object of the present invention is to provide a method for image controlling that rapidly unlocks a locked screen mode.

Another object of the present invention is to provide a portable electronic device that rapidly unlocks a locked screen mode.

According to an embodiment of the present invention, the method for image controlling is applied in a portable electronic device with a touch display module. The method comprises: defining a signal input area on the touch display module; detecting an input signal on the signal input area; and displaying a first control interface on the touch display module, wherein the displayed ratio of the first control interface varies according to changes in a sliding distance of a track formed by the input signal.

The present invention also provides a portable electronic device. According to an embodiment of the present invention, the portable electronic device comprises a touch display module and a processing module used for defining a signal input area on the touch display module, detecting an input signal on the signal input area, and displaying a first control interface on the touch display module, wherein the displayed ratio of the first control interface varies according to changes in a sliding distance of a track formed by the input signal.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 is a system architecture diagram of a portable electronic device according to an embodiment of the present invention;

FIG. 2 is a step flowchart of a method for image controlling according to an embodiment of the present invention;

FIG. 3 is a schematic diagram of a hibernation mode according to the first embodiment of the present invention;

FIGS. 4A and 4B are schematic diagrams of a first control interface according to the first embodiment of the present invention;

FIG. 5 is a schematic diagram of a second control interface according to the first embodiment of the present invention;

FIG. 6A is a schematic diagram of a hibernation mode according to the second embodiment of the present invention; and

FIG. 6B is a schematic diagram of a first control interface according to the second embodiment of the present invention.

### DETAILED DESCRIPTION OF THE PREFERRED EMBODIMENT

Embodiments are provided in the following descriptions in order to further detail the implementations of the present invention. It should be noted that objects used in the diagrams of the embodiments are provided with proportions, dimensions, deformations, displacements and details as examples and that the present invention is not limited thereto, and that identical components in the embodiments are the given the same component numbers.

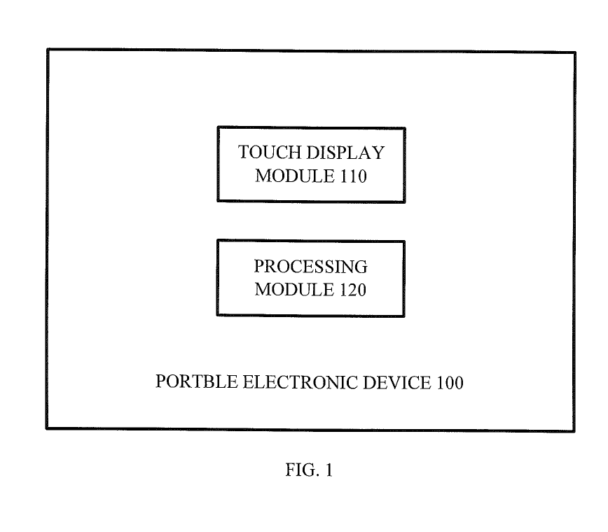

FIG. 1 is a system architecture diagram of a portable electronic device according to an embodiment of the present invention. As shown in FIG. 1, the portable electronic device 100 comprises a touch display module 110 and a processing module 120 according to an embodiment of the present invention. It should be noted that each of the above mentioned modules can be implemented by hardware devices, software applications, or combinations of the above, and that they can also be implemented by computer circuits or other suitable forms. In addition, each module can be individually implemented or implemented in a combination of the above forms. Furthermore, the described embodiment is only an example of the preferred embodiment according to the present invention. Not all possible alternative combinations are elaborated in the following descriptions. Nonetheless, it should be obvious to those skilled in the art that the above modules or components are not mandatory elements. The implementations of the present invention may comprise other detailed prior art modules or components. Each module or component can be removed or modified subject to requirements, and each two modules may comprise other modules or components.

According to an embodiment of the present invention, the portable electronic device 100 is, for example, a mobile phone, yet the scope of the present invention is not limited thereto. The portable electronic device 100 can also be an electronic device such as a Personal Digital Assistant (PDA), a Global Positioning System (GPS), a multimedia terminal, a gaming device, or a tablet computer. Each such electronic device may comprise suitable components, such as processors (microprocessors, digital signal processors, controllers, etc.), memory devices, communication interfaces, displays, input or output devices, etc.

According to an embodiment of the present invention, the touch display module 110 may be a capacitive touch panel, resistive touch panel, or any other suitable displaying devices used for displaying pictures or images and supporting single touch operation, multi touch operation, and sliding touch operation.

According to an embodiment of the present invention, the processing module 120 can be implemented by any kind of general or specific integrated circuits, for example any kinds of microprocessors, micro controllers, digital signal processors, Programmable Logic Arrays and/or similar elements, or any other suitable, general, or special processors. For example, the processing module 120 shown in FIG. 1 can be a System on a Chip (SoC), which uses any suitable processing circuits under the control of any suitable control logics.

Those skilled in the art should be able to implement the method for image controlling with any forms according to the present invention based on the requirements, such as implementation with a computer-readable storage media installed with applications. In other words, the method for image controlling according to the present invention can be implemented by applications (computer software) that are saved in a memory, a computer-readable storage medium, of the portable electronic device 100.

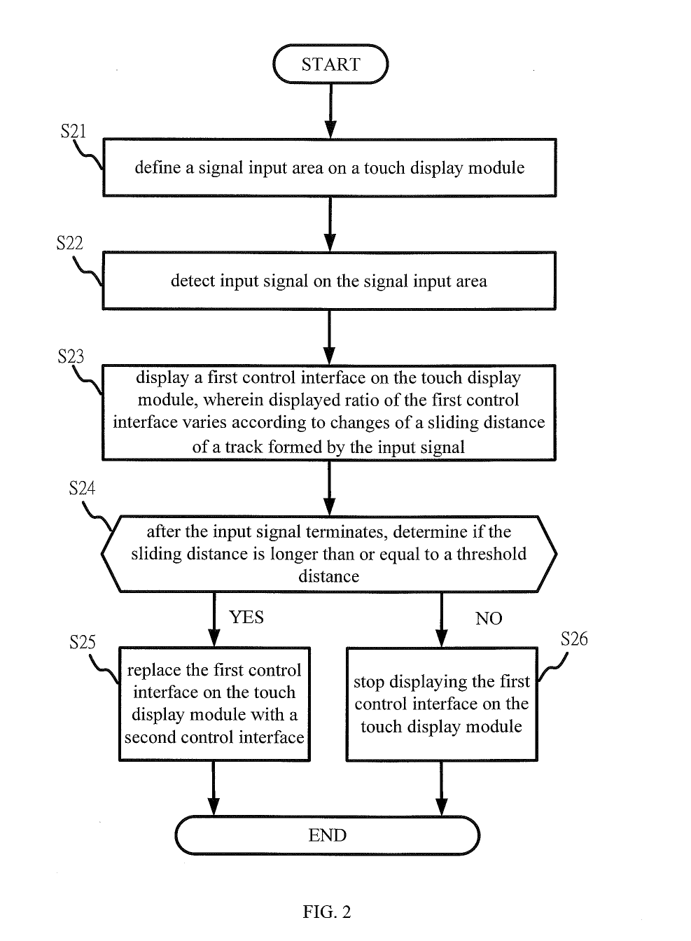

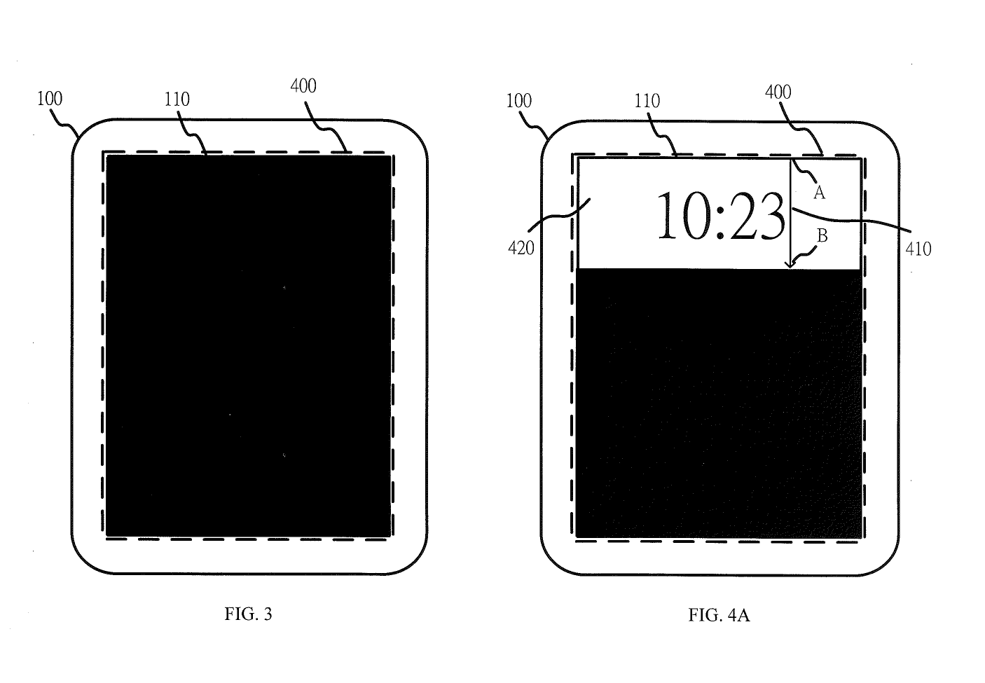

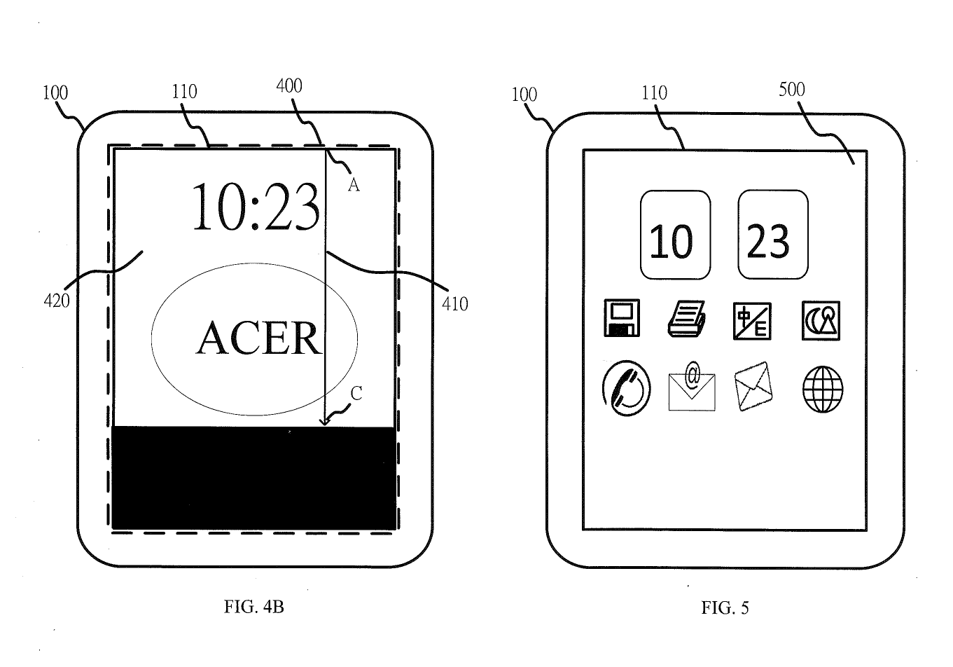

FIG. 2, FIG. 3, FIG. 4A, FIG. 4B and FIG. 5 are diagrams of an embodiment according to the present invention. FIG. 2 is a step flowchart of a method for image controlling according to an embodiment of the present invention. FIG. 3 is a schematic diagram of a hibernation mode according to the first embodiment of the present invention. FIGS. 4A and 4B are schematic diagrams of a first control interface according to the first embodiment of the present invention. FIG. 5 is a schematic diagram of a second control interface according to the first embodiment of the present invention. The portable electronic device 100 shown in FIG. 1 is used as an example for illustrating the method for image controlling according to the present invention. It should be noted that the scope of the method for image controlling according to the present invention is not limited to the portable electronic device 100 shown in FIG. 1.

First, step S21 is performed: define a signal input area on a touch display module.

In the embodiment, the portable electronic device 100 is in a standby mode in the beginning. A standby mode means that the portable electronic device 100 is powered on and is in an operating mode or a locked screen mode that is capable of performing signal connecting and operations. As shown in FIG. 3, when the portable electronic device 100 is in a standby mode, the power supply of the touch display module 110 is turned off and the touch display module 110 does not display any information and is black accordingly.

As shown in FIG. 3, in the standby mode, the processing module 120 defines a signal input area 400 on a touch display module 110. The processing module 120 is able to define the touchable part on the whole surface of the touch display module 110 as a signal input area. However, the scope of the present invention is not limited thereto. Alternatively, for example, part of the touch display module 110 can be defined as a signal input area.

Next, step S22 is performed: detect an input signal on the signal input area.

The processing module 120 detects an input signal generated by a touching action of the user on the signal input area 400. As shown in FIG. 4A and FIG. 4B, the user uses a finger or a stylus to approach or touch the signal input area 400 for generating an input signal. It should be noted that the means of the processing module 120 detecting an input signal on the signal input area 400 is known to those skilled in the art, and as part of prior art technologies, is not described herein.

Next, step S23 is performed: display a first control interface on the touch display module, wherein the displayed ratio of the first control interface varies according to changes in a sliding distance of a track formed by the input signal.

Upon the input signal being detected, the processing module 120 calculates the sliding distance of a track 410 formed by the input signal. As shown in FIG. 4A and FIG. 4B, the input tool used by the user (such as a finger or a stylus) slides on the touch display module 110 to generate a track 410. The sliding distance of the track 410 is the vertical distance on the horizontal plane between the starting point (i.e., point A in FIG. 4A and FIG. 4B) and the ending point of track 410 (i.e., point B in FIG. 4A and point C in FIG. 4B). The processing module 120 displays the first control interface 420 on the touch display module 110, wherein the displayed ratio of the first control interface 420 varies according to changes in a sliding distance of the track 410 formed by the input signal.

As shown in FIG. 4A, the user uses the input tool to slide from point A downwards to point B to generate a track 410. The first control interface 420 is not displayed before the input tool begins to slide (as shown in FIG. 3). During the sliding process of the input tool, the first control interface 420 is displayed on the touch display module 110 gradually, until the input tool stops at point B. At that time, the corresponding part of the first control interface 420 from point A to point B is displayed on the touch display module 110, and the rest of the control interface 420 is not displayed yet.

As shown in FIG. 4B, if the user does not remove the input tool and continues to slide on the touch display module 110, which lengthens the sliding distance of the track 410, the displayed ratio of the first control interface 420 also increases along with the increasing sliding distance until the input tool stops at point C. At that time, the corresponding part of the first control interface 420 from point A to point C is displayed on the touch display module 110, and the rest of the control interface 420 is not displayed yet.

Next, step S24 is performed: after the input signal terminates, determine if the sliding distance is longer than or equal to a threshold distance.

The processing module 120 continues to detect if the input tool used by the user is removed from the signal input area 400, thus stopping the input signal. When the input signal terminates, the processing module 120 determines if the sliding distance of the track 410 is longer than or equal to a threshold distance, after which step S25 or step S26 is performed. When the sliding distance is longer than or equal to the threshold distance, step S25 is performed; when the sliding distance is shorter than the threshold distance, step S26 is performed. According to an embodiment of the present invention, the threshold distance is substantially about two-thirds of the length of the signal input area 400, but the scope of the present invention is not limited thereto.

Next, step S25 is performed: replace the first control interface on the touch display module with a second control interface; or proceed to step S26: stop displaying the first control interface on the touch display module.

Please refer to FIG. 4A; if the user uses the input tool to slide to point B of the track 410 and removes the input tool from the signal input area 400, the track 410 terminates and the processing module 120 determines that the sliding distance is shorter than the threshold distance, after which step S26 is performed. In step S26, the processing module 120 stops displaying the first control interface 420 on the touch display module 110, stops displaying any screen images, and returns to a standby mode (as shown in FIG. 3).

On the other hand, as shown in FIG. 4B, if the user uses the input tool to slide to point C of the track 410 and removes the input tool from the signal input area 400, and the processing module 120 determines that the sliding distance is longer than or equal to the threshold distance, the processing module 120 stops displaying the first control interface 420 and displays the second control interface 500 on the touch display module 110 (as shown in FIG. 5). The second control interface 500 displays the full amount of information provided to users for launching every function of the portable electronic device 100. With the method flow above, the user is able to unlock the locked screen mode with a more convenient and easier procedure.

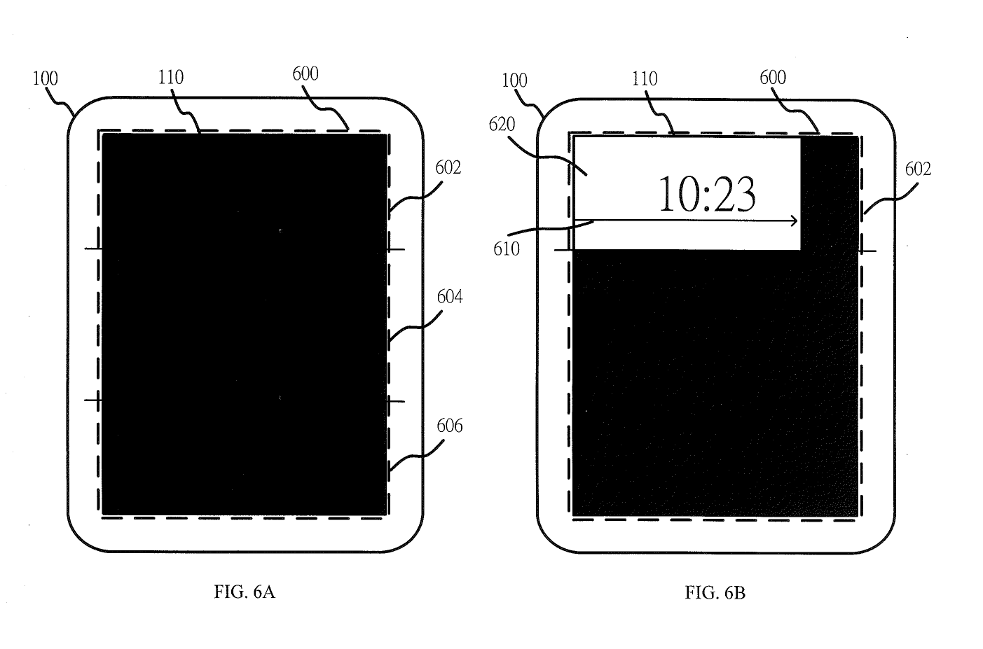

FIG. 6A and FIG. 6B are diagrams of the second embodiment according to the present invention. FIG. 6A is a schematic diagram of a hibernation mode according to the second embodiment of the present invention. FIG. 6B is a schematic diagram of a first control interface according to the second embodiment of the present invention.

As shown in FIG. 6A, the portable electronic device 100 is in a standby mode; the touch display module 110 does not display any information and the screen is black in the beginning. Similarly, the processing module 120 defines the touchable surface of the whole touch display module 110 as a signal input area 600. Unlike the signal input area 400 in the first embodiment, the signal input area 600 in the second embodiment is divided into three different blocks 602,604,606, and the blocks 602,604,606 respectively correspond to individual parts of the first control interface 620.

As shown in FIG. 6B, when the processing module 120 detects that the user slides the input tool in one of the blocks 602,604,606 to generate an input signal, the part of the first control interface 620 corresponding to the block 602 (for example, the time information in the embodiment) is displayed on the touch display module 110 according to the sliding distance of the track 610 formed by the input signal. Similarly, the displayed ratio of the first control interface 620 varies according to changes in the sliding distance.

It should be noted that the scope of the method for image controlling according to the present invention is not limited by the step sequence demonstrated above. The above step sequence can vary as long as the objectives of the present invention are achieved.

While the present invention has been particularly shown and described with reference to a preferred embodiment, it will be understood by those skilled in the art that various changes and modifications can be made to the described embodiments. It is intended that all such variations, modifications and equivalents which fall within the scope of the invention be included as defined in the accompanying claims; it is to be understood that many other possible modifications and variations can be made without departing from the spirit and scope of the invention as hereinafter claimed.

What is claimed is:

1. A method for image controlling used for a portable electronic device, wherein the portable electronic device comprises a touch display module, the method comprising:
defining a signal input area on the touch display module;
detecting an input signal on the signal input area; and
displaying a first control interface on the touch display module, wherein the displayed ratio of the first control interface varies according to changes in a sliding distance of a track formed by the input signal.

2. The method for image controlling as claimed in claim 1, further comprising:
after the input signal terminates, if the sliding distance is higher than or equal to a threshold distance, replacing the first control interface displayed on the touch display module with a second control interface.

3. The method for image controlling as claimed in claim 2, further comprising:
after the input signal terminates, if the sliding distance is lower than the threshold distance, stopping displaying the first control interface on the touch display module and displaying no image on the touch display module.

4. The method for image controlling as claimed in claim 3, wherein the threshold distance is substantially two-thirds of the length of the signal input area.

5. The method for image controlling as claimed in claim 1, wherein the signal input area comprises a plurality of blocks such that when the input signal is located within one specific block of the plurality of blocks, a part of the first control interface corresponding to the specific block on the touch display module is displayed, wherein the displayed ratio of the part varies according to changes in the sliding distance.

6. A portable electronic device, comprising:
a touch display module; and
a processing module, used for defining a signal input area on the touch display module, detecting an input signal on the signal input area, and displaying a first control interface on the touch display module, wherein the displayed ratio of the first control interface varies according to changes in a sliding distance of a track formed by the input signal.

7. The portable electronic device as claimed in claim 6, the processing module further being used such that after the input signal terminates, if the sliding distance is higher than or equal to a threshold distance, the first control interface displayed on the touch display module is replaced with a second control interface.

8. The portable electronic device as claimed in claim 7, the processing module further being used such that after the input signal terminates, if the sliding distance is lower than the threshold distance, the displaying of the first control interface on the touch display module is discontinued and no image is displayed on the touch display module.

9. The portable electronic device as claimed in claim 8, wherein the threshold distance is substantially two-thirds of the length of the signal input area.

10. The portable electronic device as claimed in claim 6, wherein the processing module is used for further defining the signal input area as comprising a plurality of blocks such that when the input signal is located within one specific block of the plurality of blocks, a part of the first control interface corresponding to the specific block on the touch display module is displayed, wherein the displayed ratio of the part varies according to changes in the sliding distance.
